(19) United States
(12) Patent Application Publication
(10) Pub. No.: US 2009/0236001 A1
(43) Pub. Date: Sep. 24, 2009

(54) DRAIN SYSTEM FOR A MOTOR VEHICLE

(76) Inventors: Suzanne DAMASKE, Howell, MI (US); Carrie Ellen HALL, Jackson, MI (US); Dan DELANEY, Pinckney, MI (US); Kenneth J. HALL, Jackson, MI (US); Andy BIALORUCKI, Lambertville, MI (US); George GRECH, Garden City, MI (US)

Correspondence Address: HARNESS, DICKEY & PIERCE, P.L.C., P.O. BOX 828, BLOOMFIELD HILLS, MI, 48303, US

(21) Appl. No.: 12/403,583

(22) Filed: Mar. 13, 2009

Related U.S. Application Data
(60) Provisional application No. 61/146,453, filed on Jan. 22, 2009.
(60) Provisional application No. 61/036,096, filed on Mar. 13, 2008.

(51) Int. Cl. B60R 15/00; F16L 27/00

(52) U.S. Cl. 137/899; 137/615; 137/798

(57) ABSTRACT

A drain system for transporting waste from a vehicle to a discharge location located spaced from the vehicle may include first, second and third modular components. The first modular component may be adapted to coupling to the vehicle and may define a first male connection. The second modular component may include a waste transfer portion extending between a first end and a second end. The first end may define a first female connection and the second end may define a second male connection. The third modular component may include an angled central portion, a first end and a second end. The first end may define a second female connection. The second end may define a waste discharge end. The drain system may further include a fourth modular component defining a first end having an opening for receiving the waste discharge end of the third modular component and a second end for interfacing with a tubular intake of the discharge location.

### CROSS-REFERENCE TO RELATED APPLICATIONS

This application claims priority to U.S. Provisional Patent Application Nos. 61/146,453 filed 22 Jan. 2009 and 61/036,096 filed 13 Mar. 2008, which applications are herein expressly incorporated by reference.

### INTRODUCTION

The present teachings generally relate to a drain system for a motor vehicle. More particularly, the present teachings relate to a modular sewer drain system for emptying a holding tank of a motor vehicle such as a recreational vehicle (RV).

### BACKGROUND OF THE INVENTION

Vehicles, including but not limited to recreational vehicles (“RVs” in the United States and “Caravans” in Europe), tractor trailers, airplanes, boats, trains, and the like, often incorporate sanitation systems for the comfort and convenience of the occupants.

Waste from the sanitation system may be stored in an on-board collection tank. Various arrangements have been employed for the period emptying of on-board collection tanks to a suitable storage location such as an underground tank or sewer. Examples of such arrangement include flexible hoses that may be stored in an external cabinet on the vehicle. Such hoses are connected to a discharge pipe on the vehicle and then manipulated to connect to an underground storage tank or the like. It is also known to provide a telescoping drain assembly for emptying on-board holding tanks. Such telescoping drain assemblies have proven to reduce associated mess and inconvenience involved with emptying of the holding tank. One example is shown and described in commonly assigned U.S. Pat. No. 4,779,650. U.S. Pat. No. 4,779,650 discloses a rotatable telescoping drain assembly permanently mounted to waste receptacle drain on the underside of a recreational vehicle. The assembly includes a swivel coupling unit attached to an axially extensible flow hose within a telescoping support tube assembly, a tie rod assembly connected to and extending between the tube assembly and the swivel coupling unit, and a discharge spout unit connected to the other end of the telescoping support tube and flow hose assembly which includes an internal valve. The telescoping tube assembly can be relatively telescoped, the swivel coupling relatively swiveled, and the tie rod relatively pivoted to locate the spout into the inlet of appropriate waste storage facility. During travel of the vehicle the discharge spout and drain assembly is supported within an enclosed cabinet mounted on the vehicle. U.S. Pat. No. 4,779,650 is incorporated by reference as if fully set forth herein. While arrangements including those discussed above have proven to be successful for their intended applications, a continuous need for improvement with the pertinent art remains.

### SUMMARY OF THE INVENTION

According to one particular aspect, the present teachings provide a drain system for transporting waste from a vehicle to a discharge location located spaced from the vehicle. The drain system may include first, second and third modular components. The first modular component may be adapted to coupling to the vehicle and may define a first male connection. The second modular component may include a waste transfer portion extending between a first end and a second end. The first end may define a first female connection and the second end may define a second male connection. The third modular component may include an angled central portion, a first end and a second end. The first end may define a second female connection. The second end may define a waste discharge end.

According to another particular aspect, the present teachings provide a drain system for transporting waste from a vehicle to a discharge location located spaced from the vehicle including a plurality of modular components and a common sealing member. The plurality of modular components interchangeable couple to define a path for transferring the waste from the vehicle to the discharge location. Each component of the plurality of components includes a least one of a male connection and a female connection. The common sealing member selectively seals one of the male connections or one of the female connections.

According to yet another particular aspect, the present teachings provide a drain system for transporting waste from a vehicle to a discharge location located spaced from the vehicle. The drain system includes a first component and a second component. The first component defines a waste discharge end. The second component defines a first end having an opening for receiving the waste discharge end of the first component and a second end for interfacing with a tubular intake of the discharge location.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a drain system for a motor vehicle.

FIG. 2 is an exploded perspective view of the drain system for a motor vehicle of FIG. 1.

FIG. 3 is a perspective view of a first modular component of the drain system of FIG. 1.

FIG. 4A is a side view of the first modular component of FIG. 3.

FIG. 4B is another perspective view of the first modular component of FIG. 3.

FIG. 5 is a perspective view of a portion of a second modular component of FIG. 1, the second modular component shown operatively coupled with the first modular component.

FIG. 6 is a perspective view of the first and second modular components of FIG. 5 shown prior to coupling.

FIGS. 7A and 7B are perspective views of a cap in accordance with the present teachings, the cap operative for sealing one or more other components.

FIGS. 8A-8E are various views of a third modular component of the drain system of FIG. 1.

FIGS. 9A-9D are various views of a fourth modular component of the drain system of FIG. 1.

### DESCRIPTION OF VARIOUS ASPECTS

The following description of various aspects of the present teachings is merely exemplary in nature and is in no way intended to limit the invention, its application or uses.

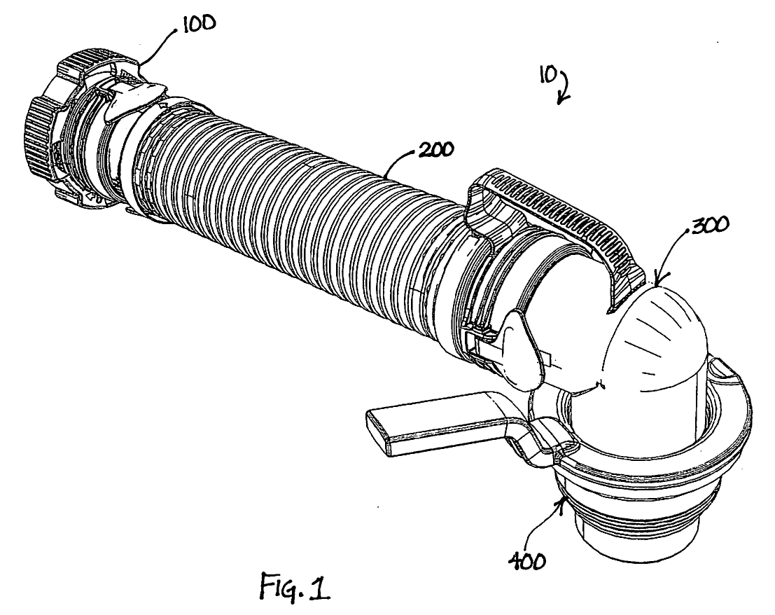

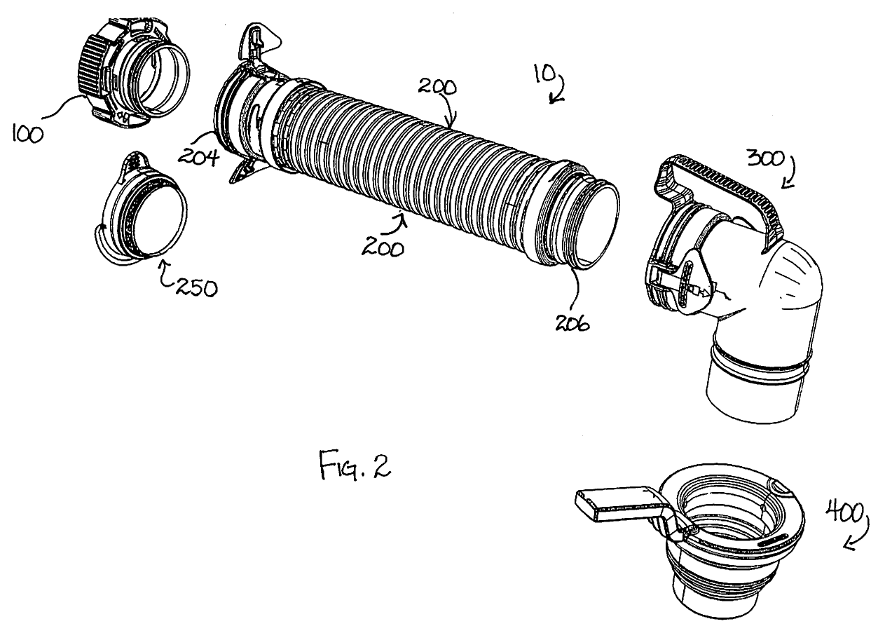

With initial reference to FIGS. 1 and 2, a drain system in accordance with the present invention is illustrated and generally identified at reference character 10. As will become more apparent below, the drain system 10 may provides a user with a system that can be quickly and easily assembled to have various functional capabilities for emptying holding tanks of motor vehicles to a location spaced from the vehicle such as a sewage disposal area. For example, the present teachings may be used to adapt an RV waste holding tank for emptying to a sewer. While particularly adapted for an RV, however, it will be understood that the present teachings are not so limited. In this regard, the present teachings have application for marine vehicles and other situations involving the transfer of waste or wastewater to a disposal area.

The drain system 10 may generally include a plurality of modular units or components. The modular components may generally include a first component 100, a second component 200, a third component 300, and a fourth component 400. The drain system 10 may further include a cap member 250.

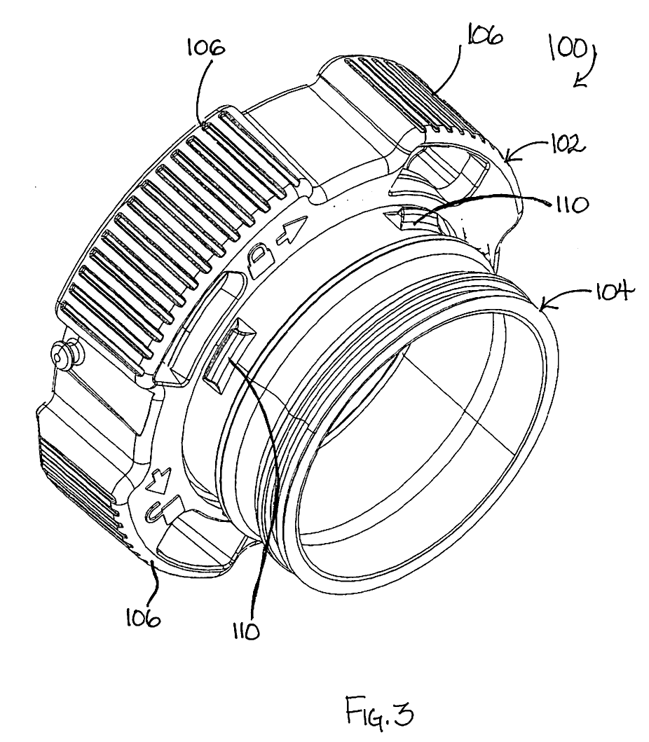

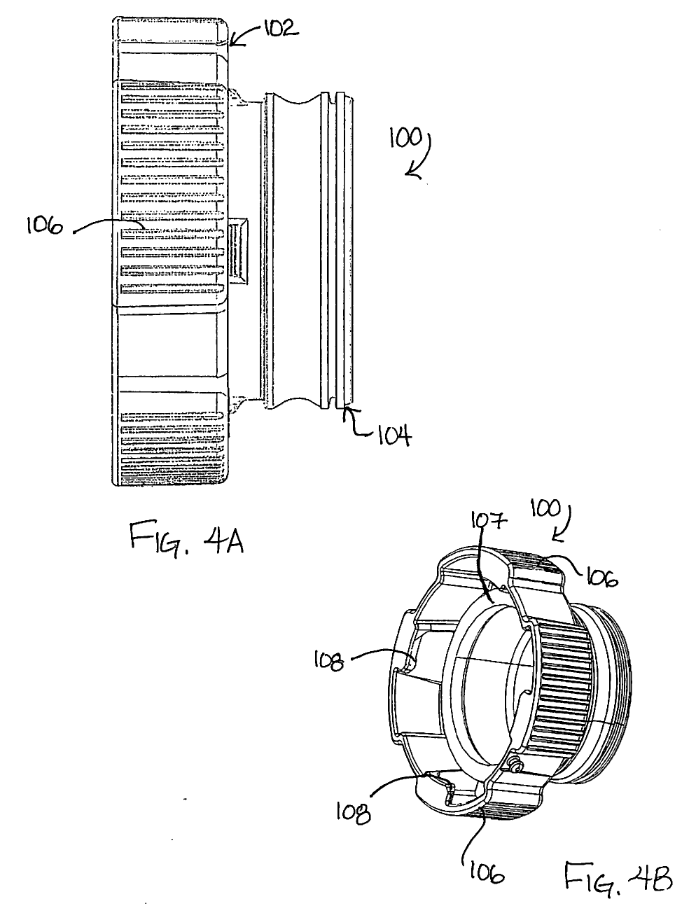

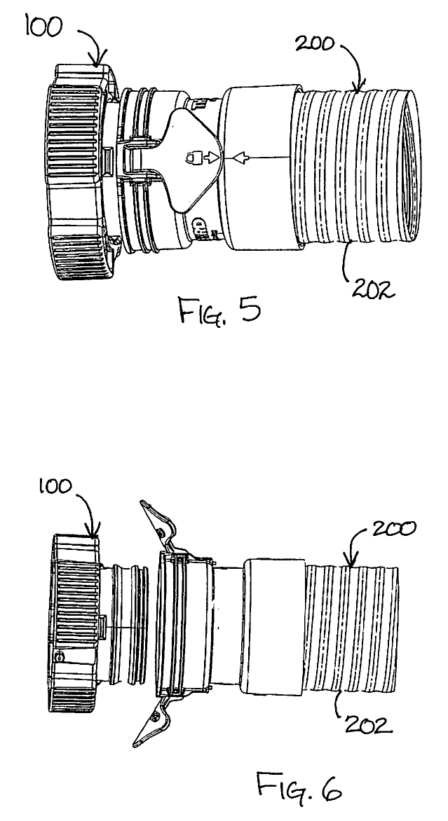

With continued reference to FIGS. 1 and 2 and additional reference to FIGS. 3, 4A and 4B, the first modular component or unit of the present teachings may comprise an RV fitting 100. The first modular component 100 may generally function to couple a waste receptacle drain of a vehicle with the second modular component 200. In this regard, the first modular component 100 may be integrally formed of any suitable material to generally include a first end 102 for coupling to the waste receptacle drain and a second end 104 for coupling to the second modular component 200.

The first modular component 100 fitting may have a radial mechanism design for ergonomic and geriatric considerations. The actuation effort requirement may be low through part geometry and use of a compressible seal 107. Positive detents 108 may be incorporated to cooperate with the waste receptacle drain and signal that connection has been made.

The first modular component 100 may include an integral grip surface. As illustrated, the first portion 102 of the first modular component 100 may include a plurality of radially extending segments 106. In the embodiment illustrated, the plurality of radially extending segments 106 may include four segments. It will be appreciated, however, that a greater or lesser number of segments may be incorporated. The segments 106 may be equally spaced about the perimeter of the first portion 102 and may be formed to include grip surfaces. The grip surfaces may comprise a plurality of axially extending grooves.

The first modular component 100 may optionally incorporate a flex joint (not particularly shown). The flex joint may extend, retract and provide a rotational joint for positioning the next modular unit (e.g., the second modular component 200) to be connected. The coupler end may allow for connection in a free state without requiring a specific orientation. It provides an engagement point for the next modular component. The coupler mechanism may enable a user to more easily connect and disconnect the parts without rotation. Such infinite position attachment may create a coupling between parts in their free state with no twisting or bending. The first modular component 100 may have the ability to include many additional modular features but is not limited to a valve, a wash out assembly, a chemical introduction cartridge and a flex joint.

The second portion 104 of the first modular component may be generally cylindrical and may define a reduced diameter portion relative to the first portion 102. The first portion 102 may include a plurality of detents 110. The detents 110 may be radially spaced about the second portion 104. The second portion 104 may define a male connection member for coupling with an adjacent modular component (e.g., the second modular component 200).

As shown in FIGS. 1 and 2, the second modular component 200 may extend between adjacent modular components. The second modular component 200 may include, but is not limited to, a macerator, a telescoping tube set, and hose assemblies. These modular units may be coupled into the drain system independently or coupled to function together with a bypass/valve system. The system may allow the user to modify the system depending on a length of stay or particular hook-up. The modular units may remain coupled to each other for storage as a self-contained system. In situations where the user has limited space, the modular units may be decoupled in various lengths/combinations and stowed independently.

In the particular embodiment illustrated, the second modular component 200 includes a central hose member or waste transfer member 202, a first end 204 and a second end 206. The first end 204 may define a female connection member. The second end 206 may define a male connection member. The first end 204 may incorporate a latching arrangement for coupling to a male connection component of an adjacent modular component. The latching arrangement may be substantially similar to a latching arrangement of the third modular component 300 which is described further below. The male connection member of the second end 206 may be substantially identical to the male connection member of other components (e.g., of the first modular component 100) to facilitate variable interconnection between the various components.

The waste transfer member 202 may simply include a standard sewer hose. In various embodiments, the waste transfer member 202 may be tubular or flat and may further include a retractable, co-extruded material with or without an exoskeleton for protection and durability. The waste transfer member 202 may contain a plastic helix for improved product performance. An optional exoskeleton may be incorporated. In this regard, a plastic helix may be molded on an outside of a main body of the hose. The main body of the waste transfer member 202 may be formed of a flexible rubber that does not retain its form. The plastic helix may be flexible and form-retaining.

The second modular component 200 may include additional features such as a device to warn of a trip hazard, internal sprinkler/chemical introduction system for deodorizing and sanitizing, flow indicator and/or clean out capability. The components and features of this modular unit may be connected by mechanical fastening, chemical bonding or sequential molding. The second modular component 200 may include an optional tote, or be part of the tube set for storage. It may also be included in an integral storage compartment in the vehicle/source.

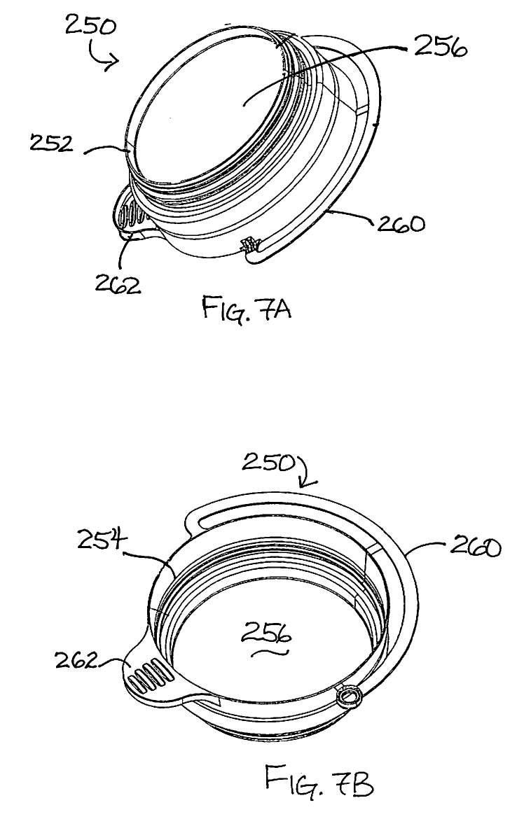

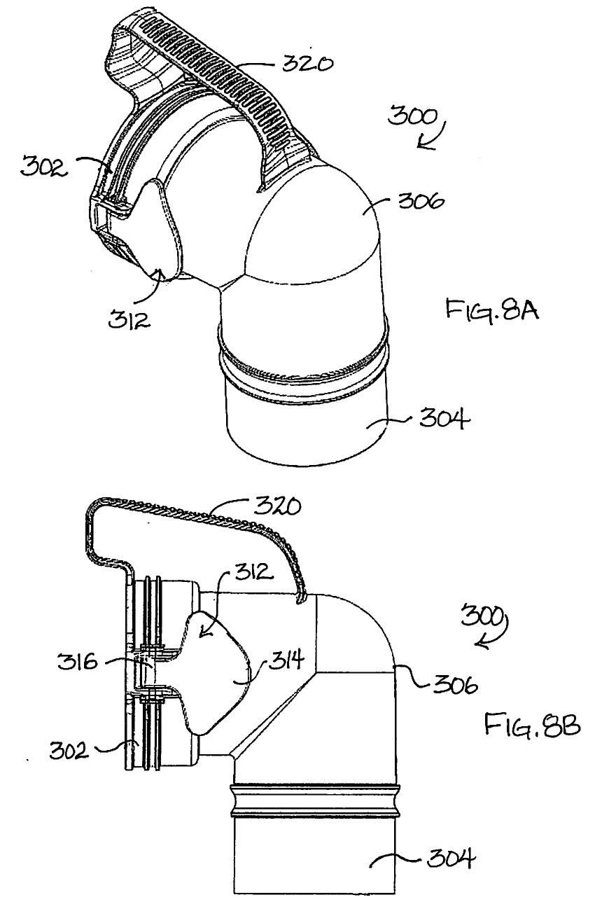

Attachment of the first modular component 100 to the second modular component 200 is shown particularly in FIGS. 5 and 6. FIG. 5 shows the components 100 and 200 as they are connected. FIG. 6 shows the components prior to connection. The latching of these components will be described further below with respect to the coupling between the second and third modular components 200 and 300 which will be understood to be substantially identical.

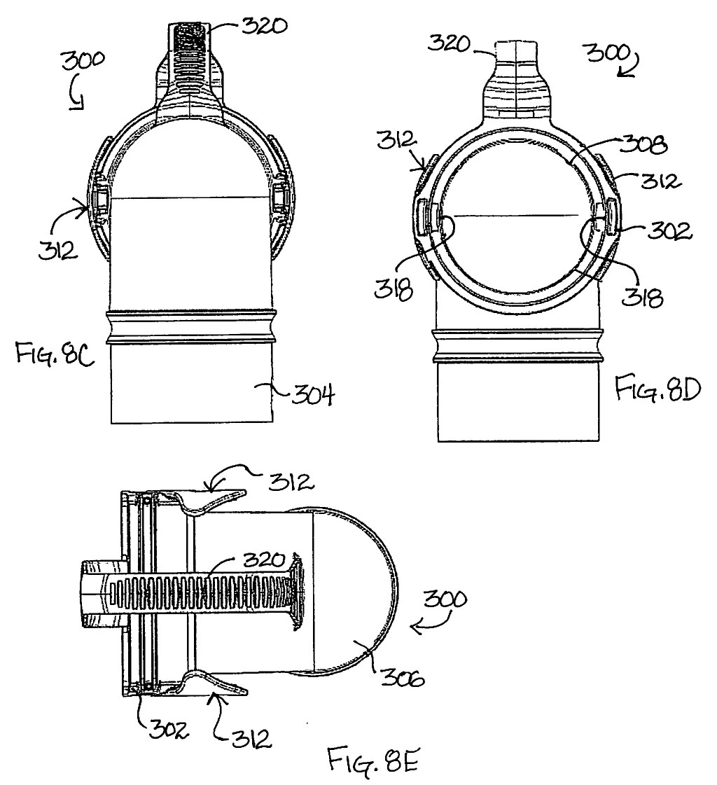

With particular reference to FIGS. 7A and 7B, the cap member 250 is illustrated. The cap member 250 may be particular adapted for selective engagement with either a male connection component or a female connection component of one of the modular components of the present teachings. In this regard, the cap member 250 may define a first end or male end 252 and a second end or female end 254. The cap member 250 may be attached to either end of the various modular components to provide sanitary storage.

The male end 252 may be sized and configured to be received by a female connection component of one of the modular components. In this regard, an outer diameter of the male end 252 may be formed similar to the male connection end of the various modular components of the present teachings. Conversely, the female end 254 may be sized and configured to be received by a male connection component of one of the modular components. An inner diameter of the female end 254 may be formed similar to the female connection end of the various modular components of the present teachings. Again, the common end wall 256 may serve to block flow through the adjacent modular component.

The cap member 250 may be integrally formed of any suitable material. The cap member 250 may be formed to include an integral tether 260 and an integral handle 262. The handle 262 may radially extend from a main body portion of the cap member 250. The integral tether 260 may extend about a portion of the periphery of the main body portion and may be secured to the main body portion at spaced apart points.

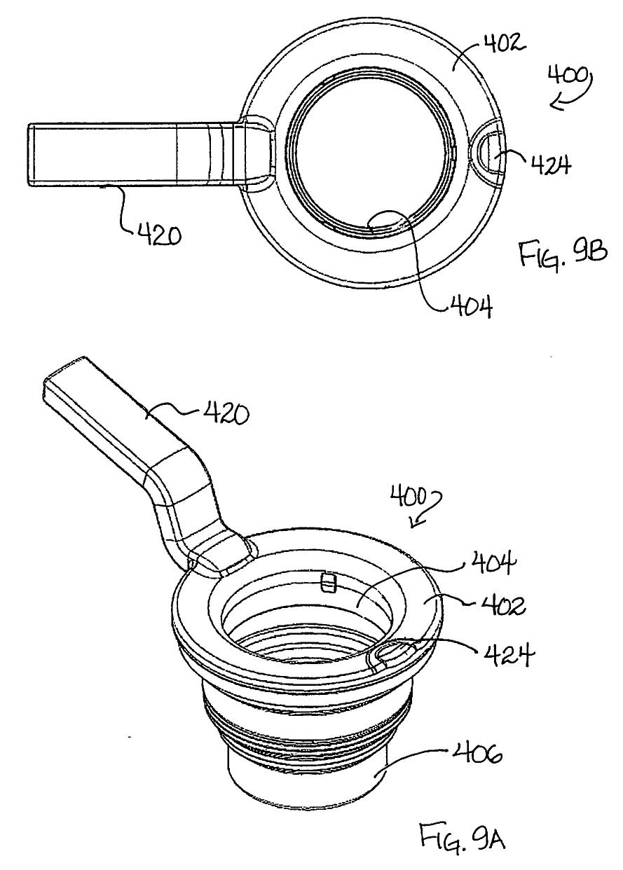

With particular reference to FIGS. 8A through 8e, the third modular component 300 will be described. The third modular component 300 may be a spout/nozzle for interconnecting the second modular component 200 with the fourth modular component 400. For example, the third modular component 300 may general function for selective and releasably couple a waste transfer component (e.g., the second modular component 200) with a sewer adapter (e.g., the fourth modular component 400). Alternatively, the third modular component 300 may directly deliver waste to a remote location such as a stationary holding tank or sewer.

The third modular component 300 may include a first end 302, a second end 304 and a central body 306. The first end 302 may define a female connection component for selectively engaging a male connection component of an adjacent module. The second end 304 may define a waste discharge end. The central body 306 may orientate the first and second ends 302 and 304 at an angle relative to one another. As illustrated, the angle may be approximately 90 degrees.

As discussed above, the first end 302 may carry a latching arrangement for coupling adjacent components. The latching arrangement may comprise a universal coupling device that may eliminate the need for rotational attachment, resulting in improved durability and attachment performance. In this regard, the first end 302 may define an opening 308 adapted to receive a male connection component when the male connection component is advanced into the opening 308 in a generally axially direction.

The latching arrangement may include one or more cam lever locking mechanisms 312. In the embodiment illustrated, the latching arrangement includes two substantially identical cam lever locking mechanisms 312. The locking mechanisms 312 may be positioned on radially opposite sides of the first end 302. The locking mechanism may include an integrally formed member having a first end or handle 314 and a second end 316.

The first end 314 may be an enlarged, cantilevered end to reduce effort. The first end may be curved to generally follow the adjacent curvature of the third modular component 300. The second end 316 may be pivotally coupled to the third modular component 300 and may include a cam portion 318 extending into the interior of the first end 302. The cam portion 318 may be particularly adapted to cooperate with a male connection component of an adjacent modular component to secure the components upon rotation from a first position to a second position. The first position is shown in FIG. 6, for example. The second position is shown in FIG. 5, for example. To the extent not otherwise described herein, it will be understood that the latching mechanisms cooperate with adjacent male connection components in a conventional manner.

The third modular component 300 may be formed to integrally include a handle 320. The handle 320 may comprise a strap extending between the first end 302 and the central portion 306. A central portion of the handle may extend generally parallel to an adjacent portion of the third modular component 300. The central portion may be formed to include grooves or other grip enhancing structure.

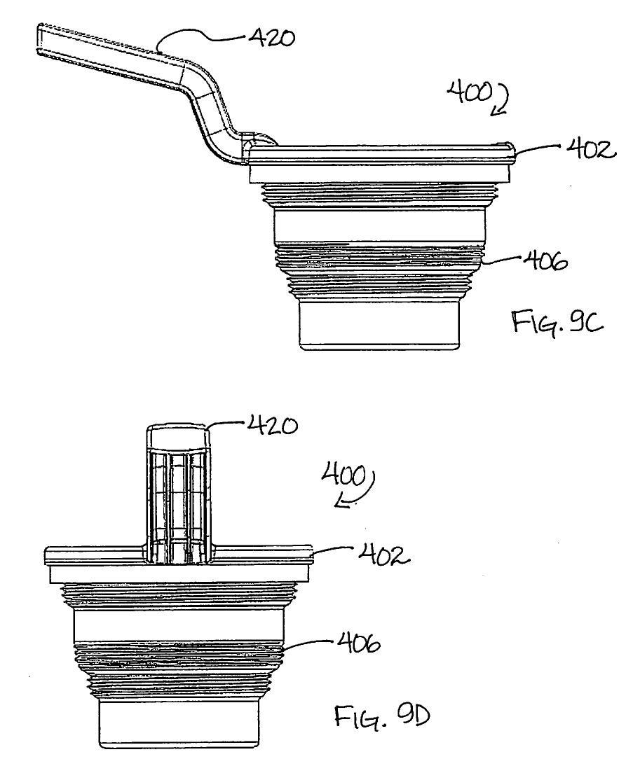

With particular reference to FIGS. 9A-9B, the fourth modular component or sewer fitting 400 will be further described. The fourth modular component 400 may generally function to couple the third component 300 with a remote waste disposal area. As noted above, however, the third modular component 300 may alternatively be coupled directly to a sewer fitting bypassing the fourth modular component 400.

The fourth modular component 400 may generally include a first end 402 defining an opening 404 for receiving the end 304 of the third modular component 300. The fourth modular component 400 may further generally include a second end 404 defining a plurality of interface features for coupling to various tubular elements. In the embodiment illustrated, the second end 406 may define five integral interface features. It will be appreciated by those skilled in the art, however, that a greater or lesser number of interface features may be incorporated. The integral interface features of the second end 406 may include a combination of threaded and unthreaded interface features of various diameters.

The fourth modular component 400 may additionally incorporate a handle 420. The handle may be integrally formed with the remained of the fourth modular component 400. As shown, the handle 400 may radially extend from the first end 402 of the fourth modular component 400. A rim 422 of the first end 402 may define a depression 424 to assist the user.

The above description describes an exemplary construction incorporating the various teachings of the present system 10. It will now be understood that alternative constructions may incorporate a greater number or a lesser number of modular components. Additionally, it will be understood that the various components may be interchangeable coupled within the scope of the present teachings. Further in this regard, while specific examples have been described in the specification and illustrated in the drawings, it will be understood by those skilled in the art that various changes may be made and equivalence may be substituted for elements thereof without departing from the scope of the present teachings as defined in the claims. The mixing and matching of features, elements and/or functions between various examples may be expressly contemplated herein so that one skilled in the art would appreciate from the present teachings that features, elements and/or functions of one example may be incorporated into another example as appropriate, unless described otherwise above. Moreover, many modifications may be made to adapt a particular situation or material to the present teachings without departing from the essential scope thereof. Therefore, it may be intended that the present teachings not be limited to the particular examples illustrated by the drawings and described in the specification as the best mode of presently contemplated for carrying out the present teachings but that the scope of the present disclosure will include any embodiments following within the foregoing description.

What is claimed is:

1. A drain system for transporting waste from a vehicle to a discharge location located spaced from the vehicle, the drain system comprising:
a first modular component for coupling to the vehicle, the first modular component defining a first male connection;
a second modular component including a waste transfer portion extending between a first end and a second end, the first end defining a first female connection and the second end defining a second male connection; and
a third modular component including an angled central portion, a first end and a second end, the first end defining a second female connection, the second end defining a waste discharge end.

2. The drain system for transporting waste of claim 1, further comprising a fourth modular component, the fourth modular component defining a first end having an opening for receiving the waste discharge end of the third modular component and a second end for interfacing with a tubular intake of the discharge location.

3. The drain system for transporting waste of claim 1, wherein the second end of the fourth modular component includes a plurality of integral interface features.

4. The drain system for transporting waste of claim 3, wherein the plurality of integral interface features includes at least five interface features.

5. The drain system for transporting waste of claim 3, wherein the plurality of integral interface features includes a combination of threaded and unthreaded interface features of various diameters.

6. The drain system for transporting waste of claim 1, further comprising a sealing cap for selectively sealing one of the first and second male connection or one of the first and second female components.

7. The drain system for transporting waste of claim 6, wherein the sealing cap includes a male end adapted to seal one of the first and second male connections and a female end adapted to seal one of the first and second male connections.

8. A drain system for transporting waste from a vehicle to a discharge location located spaced from the vehicle, the drain system comprising:
a plurality of modular components for interchangeable coupling to define a path for transferring the waste from the vehicle to the discharge location, each component of the plurality of components including a least one of a male connection and a female connection; and
a common sealing member for selectively sealing one of the male connections or one of the female connections.

9. The drain system for transporting waste of claim 8, wherein the common sealing member is integrally formed to including a male end, a female end, and a sealing panel shared by the male and female ends.

10. The drain system for transporting waste of claim 9, wherein an outer diameter of the male end selectively receives one of the male connections and the female end selectively receives one of the female connections.

11. The drain system for transporting waste of claim 8, wherein at least one of the modular components includes a first male end and a first female end.

12. A drain system for transporting waste from a vehicle to a discharge location located spaced from the vehicle, the drain system comprising:
a first component defining a waste discharge end; and
a second component defining a first end having an opening for receiving the waste discharge end of the first component and a second end for interfacing with a tubular intake of the discharge location.

13. The drain system for transporting waste of claim 12, wherein the second end of the second component includes a plurality of integral interface features.

14. The drain system for transporting waste of claim 13, wherein the plurality of integral interface features includes at least five interface features.

15. The drain system for transporting waste of claim 13, wherein the plurality of integral interface features includes a combination of threaded and unthreaded interface features of various diameters.

16. The drain system for transporting waste of claim 1, wherein the waste transfer portion of the second modular component includes a plastic helix.

17. The drain system for transporting waste of claim 1, wherein the waste transfer portion includes a main body and a plastic helix molded on an outside of the main body.

18. The drain system for transporting waste of claim 17, wherein the main body of the waste transfer portion is formed of a flexible and non-form retaining rubber and the plastic helix is flexible and memory retaining.
